(19) United States
(12) Patent Application Publication
(10) Pub. No.: US 2008/0131733 A1
(43) Pub. Date: Jun. 5, 2008

(54) PERPENDICULAR MAGNETIC RECORDING MEDIUM AND MAGNETIC RECORDING/REPRODUCING APPARATUS

(75) Inventor: Tomoyuki Maeda, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/947,975

(22) Filed: Nov. 30, 2007

(30) Foreign Application Priority Data
Nov. 30, 2006 (JP) 2006-324994

(51) Int. Cl. G11B 5/66; G01D 9/00

(52) U.S. Cl. 428/828.1; 346/135.1

(57) ABSTRACT

According to one embodiment, disclosed is a perpendicular magnetic recording medium in which a magnetic recording layer has a stacked structure including a hard magnetic recording layer and soft magnetic recording layer each having magnetic crystal grains and a grain boundary region. The magnetic crystal grains in the hard magnetic recording layer contain Co and Pt, have the hcp structure, and are orientated in the (0001) plane. The magnetic recording layer has a residual squareness ratio of 0.95 or less and an irreversible reversal magnetic field of 0 Oe or less on a magnetization curve when a magnetic field perpendicular to the substrate surface is applied.

### CROSS-REFERENCE TO RELATED APPLICATIONS

This application is based upon and claims the benefit of priority from Japanese Patent Application No. 2006-324994, filed Nov. 30, 2006, the entire contents of which are incorporated herein by reference.

### BACKGROUND

1. Field

One embodiment of the invention relates to a perpendicular magnetic recording medium and magnetic recording/reproducing apparatus to be used in, e.g., a hard disk drive using the magnetic recording technique.

2. Description of the Related Art

Magnetic storage devices (HDDs) mainly used in computers to record and reproduce information are recently beginning to be used in various applications because they have large capacities, inexpensiveness, high data access speeds, high data storage reliability, and the like, and they are now used in various fields such as household video decks, audio apparatuses, and automobile navigation systems. As the range of applications of the HDDs extends, demands for large capacities increase, and high-density HDDs are more and more extensively developed in recent years.

Presently commercially available magnetic recording/reproducing apparatuses use the longitudinal magnetic recording method. In this method, magnetic crystal grains forming a perpendicular magnetic recording layer for recording information have the easy magnetization axis parallel to a substrate. The easy magnetization axis is an axis in the direction of which magnetization easily points. In the case of a Co-based alloy, the easy magnetization axis is a direction parallel to the normal of the (0001) plane of the hexagonal close-packed structure (hcp) of Co. When recording bits of a longitudinal magnetic recording medium are downsized in order to increase the recording density, the magnetization reversal unit diameter of the magnetic layer may become too small, and the thermal decay effect that thermally erases information in the magnetic layer may worsen the recording/reproduction characteristics. In addition, as the density increases, the influence of a demagnetizing field generated in the boundary region between the recording bits often increases noise produced from the medium.

By contrast, in a so-called perpendicular magnetic recording method in which the easy magnetization axis in a perpendicular magnetic recording layer is almost perpendicular to the substrate, the influence of the demagnetizing field between the recording bits is small and the medium is magnetostatically stable even when the density increases. Therefore, the perpendicular magnetic recording method is recently attracting a good deal of attention as a technique that replaces the longitudinal recording method. The perpendicular magnetic recording medium generally comprises a substrate, an orientation control underlayer that orientates magnetic crystal grains in a perpendicular magnetic recording layer in the (0001) plane and also reduces the orientation dispersion, the perpendicular magnetic recording layer containing a hard magnetic material, and a protective layer that protects the surface of the perpendicular magnetic recording layer. In addition, a soft magnetic underlayer that concentrates magnetic fluxes generated from a magnetic head during recording is formed between the substrate and orientation control underlayer.

To increase the recording density of even the perpendicular magnetic recording medium, it is necessary to reduce noise while maintaining the thermal stability. A method generally used as the noise reduction method is to reduce the magnetic interaction between the magnetic crystal grains in the recording layer by magnetically isolating the magnetic crystal grains, and downsize the magnetic crystal grains themselves at the same time. It is disclosed by, for example, Jpn. Pat. Appln. KOKAI Publication No. 2002-83411 has disclosed a method of forming a perpendicular magnetic recording layer having a so-called granular structure by adding SiO₂ and the like to the recording layer so as to surround magnetic crystal grains with a grain boundary region mainly containing these additives.

On the other hand, when reducing noise by the method as described above, it is inevitably necessary to increase the magnetic anisotropic energy of the magnetic crystal grains in order to ensure the thermal stability. If the magnetic anisotropic energy of the magnetic crystal grains is increased, however, the anisotropic magnetic field, saturation magnetic field, and coercive force also increase. Since this increases the recording magnetic field necessary for magnetization reversal for data write as well, the writability of a recording head decreases. As a consequence, the recording/reproduction characteristics deteriorate.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a sectional view showing an example of a perpendicular magnetic recording medium according to an embodiment of the invention;

FIG. 2 is a graph showing magnetization curves of an example of a comparative perpendicular magnetic recording medium;

FIG. 3 is a graph showing magnetization curves of the example of the perpendicular magnetic recording medium according to the embodiment;

FIG. 4 is a graph showing schematic magnetization curves for explaining one definition of a term according to one embodiment of the invention;

FIG. 5 is a sectional view showing the perpendicular magnetic recording medium according to a second embodiment of the invention;

FIG. 6 is a partially exploded perspective view showing a magnetic recording/reproducing apparatus according to one embodiment of the invention;

FIG. 7 is a view schematically showing the section of a perpendicular magnetic recording medium according to an embodiment of the invention;

FIG. 8 is a graph showing the relationship between the soft magnetic recording layer film thickness and a residual squareness ratio Rs of the perpendicular magnetic recording medium according to the embodiment of the invention;

FIG. 9 is a graph showing the relationship between the soft magnetic recording layer film thickness and an irreversible reversal magnetic field Hi of the perpendicular magnetic recording medium according to the embodiment of the invention;

FIG. 10 is a graph showing the relationship between the soft magnetic recording layer film thickness and a coercive force Hc of the perpendicular magnetic recording medium according to the embodiment of the invention;

FIG. 11 is a graph showing the relationship between the soft magnetic recording layer film thickness and the SNR of the perpendicular magnetic recording medium according to the embodiment of the invention;

FIG. 12 is a graph showing the relationship between the soft magnetic recording layer film thickness and the OW of the perpendicular magnetic recording medium according to the embodiment of the invention;

FIG. 13 is a graph showing the relationship between the soft magnetic recording layer film thickness and the V1000/V0 of the perpendicular magnetic recording medium according to the embodiment of the invention;

FIG. 14 is a graph showing the relationship between the Co composition of a CoNi SiO₂ soft magnetic recording layer and the medium SNR;

FIG. 15 is a graph showing the relationship between the Co composition of the CoNi SiO₂ soft magnetic recording layer and the OW;

FIG. 16 is a graph showing the relationship between the Co composition of the CoNi SiO₂ soft magnetic recording layer and the thermal decay resistance;

FIG. 17 is a graph showing the relationship between the Pd interlayer film thickness and the residual squareness ratio Rs;

FIG. 18 is a graph showing the relationship between the Pd interlayer film thickness and the irreversible reversal magnetic field Hi;

FIG. 19 is a graph showing the relationship between the Pd interlayer film thickness and the coercive force Hc;

FIG. 20 is a graph showing the relationship between the Pd interlayer film thickness and the medium SNR;

FIG. 21 is a graph showing the relationship between the Pd interlayer film thickness and the OW; and

FIG. 22 is a graph showing the relationship between the Pd interlayer film thickness and the thermal decay resistance.

### DETAILED DESCRIPTION

Various embodiments according to the invention will be described hereinafter with reference to the accompanying drawings. In general, according to one embodiment of the invention, a perpendicular magnetic recording medium of the present invention basically comprises a substrate, and a soft magnetic underlayer, nonmagnetic underlayer, and magnetic recording layer sequentially stacked on the substrate. This magnetic recording layer is a multilayered magnetic recording layer having a stacked structure of a hard magnetic recording layer and soft magnetic recording layer. Also, each of the hard magnetic recording layer and soft magnetic recording layers has magnetic crystal grains and a grain boundary region surrounding the magnetic crystal grains. In addition, the magnetic crystal grains in the hard magnetic recording layer contain Co and Pt, has the hcp structure, and are orientated in the (0001) plane. Furthermore, this magnetic recording layer has a residual squareness ratio of 0.95 or less and an irreversible reversal magnetic field of 0 Oe or less on a magnetization curve when a magnetic field perpendicular to the substrate surface is applied.

A magnetic recording/reproducing apparatus of the present invention is a magnetic recording/reproducing apparatus to which the perpendicular magnetic recording medium of the present invention is applicable, and has the perpendicular magnetic recording medium and a recording/reproducing head.

The present invention provides a perpendicular magnetic recording medium having a high medium SNR, a good overwrite (OW) characteristic, and a high thermal decay resistance, and makes high-density recording feasible.

The present invention uses the soft magnetic recording layer and hard magnetic recording layer each having the magnetic crystal grains and grain boundary region as the recording layer. The soft magnetic recording layer has a weak coercive force and small saturation magnetic field, and the hard magnetic recording layer has a high thermal decay resistance. The present invention also uses a stacked soft magnetic recording layer structure. When a magnetic field perpendicular to the substrate surface is applied, the residual squareness ratio is 0.95 or less, and the irreversible reversal magnetic field is 0 Oe or less. This makes it possible to reduce the medium noise, improve the writability, and increase the thermal decay resistance at the same time.

This is so presumably because when the exchange coupling force is moderately exerted between the magnetic crystal grains in the soft magnetic recording layer and the magnetic crystal grains in the hard magnetic recording layer, the two layers do not completely coherently reverse magnetization; prior to magnetization reversal in the hard magnetic recording layer, the soft magnetic recording layer can start reversible magnetization rotation before the applied magnetic field reaches the reversal magnetic field in the hard magnetic recording layer.

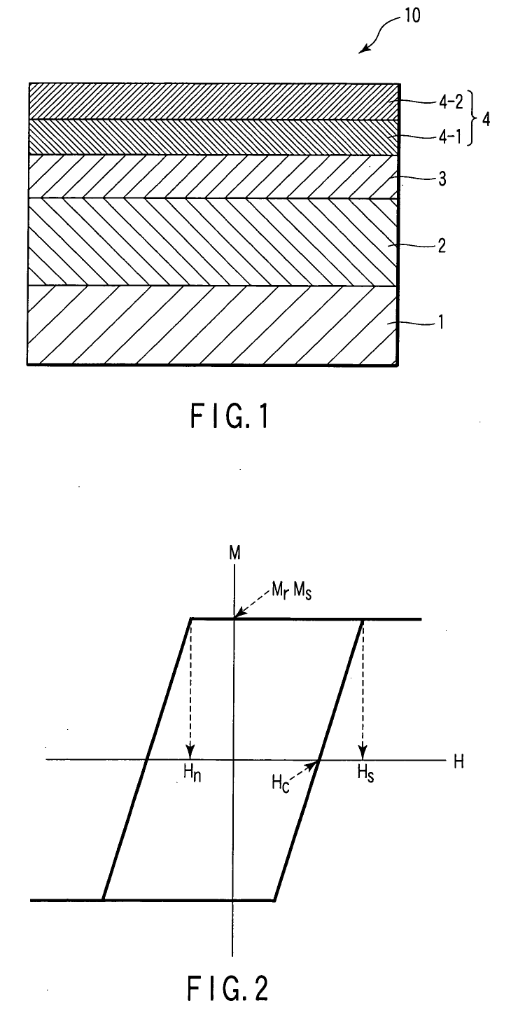

FIG. 1 is a sectional view showing an example of the perpendicular magnetic recording medium according to the present invention.

As shown in FIG. 1, a perpendicular magnetic recording medium 10 has a structure in which a soft magnetic underlayer 2, nonmagnetic underlayer 3, and perpendicular magnetic recording layer 4 are sequentially stacked on a substrate 1. The perpendicular magnetic recording layer 4 has two layers, i.e., a hard magnetic recording layer 4-1 and soft magnetic recording layer 4-2.

In the magnetic recording layer of the perpendicular magnetic recording medium of the present invention, the hard magnetic recording layer can be a single layer or a stacked structure of two or more layers. The soft magnetic recording layer can also be a single layer or a stacked structure of two or more layers.

The hard magnetic recording layer of the perpendicular magnetic recording medium of the present invention has the granular structure in which the nonmagnetic grain boundary region surrounds the magnetic crystal grains.

As the magnetic crystal grain material used in the hard magnetic recording layer, it is possible to use an alloy material practically orientated in the (0001) plane, containing Co and Pt, and having the hcp structure. When Co alloy crystal grains having the hcp structure are orientated in the (0001) plane, the easy magnetization axis readily points in a direction perpendicular to the substrate surface. It is also possible to use, e.g., a Co—Pt-based alloy material or Co—Pt—Cr-based alloy material. These alloys have high crystal magnetic anisotropic energy, and hence increase the thermal decay resistance of the magnetic recording medium. To improve the magnetic characteristics, at least one additive element selected from the group consisting of Ta, Cu, B, and Nd can be added to these alloy materials if necessary.

Whether the magnetic recording layer has the granular structure can be confirmed by observing the magnetic recording layer surface by using, e.g., a transmission electron microscope (TEM). When energy dispersion X-ray analysis (EDX) is used together, it is possible to determine the elements in the magnetic crystal grains and grain boundary region, and evaluate the compositions of these elements.

The orientation plane of the magnetic crystal grains in each layer can be evaluated by the θ-2θ method by using, e.g., a general X-ray diffraction apparatus (XRD).

The soft magnetic recording layer used in the present invention has the granular structure similar to the hard magnetic recording layer described above.

The soft magnetic recording layer and hard magnetic recording layer having the granular structure are used to form the nonmagnetic grain boundary region around the magnetic crystal grains in the magnetic recording layer, thereby reducing the exchange interaction between the magnetic crystal grains. This makes it possible to reduce the transition noise in the recording/reproduction characteristics.

In the present invention, a layer in which the saturation magnetization amount is larger than that of the hard magnetic recording layer and the magnetic anisotropic energy perpendicular to the film surface is lower than that of the hard magnetic recording layer can be used as the soft magnetic recording layer. More specifically, it is possible to use a layer in which the saturation magnetization amount is 700 to 1,700 emu/cc and the magnetic anisotropic energy perpendicular to the film surface is 2×10⁶ erg/cc or less. As the magnetic crystal grain material of the soft magnetic recording layer meeting the conditions, Fe, Co, or an alloy containing 35% or more of Fe or Co can be used. Examples are Fe—Co, Fe—Ni, and Co—Ni alloys. A Co—Ni alloy is favorable from the viewpoint of the oxidation resistance. In this case, the Co composition in the Co—Ni alloy can be 45 to 80 at. %.

A compound such as an oxide, nitride, or carbide can be used as the material forming the grain boundary region of the hard magnetic recording layer and soft magnetic recording layer. These compounds readily deposit because they hardly form any solid solution with the magnetic crystal grain materials described above. Practical examples are SiOₓ, TiOₓ, CrOₓ, AlOₓ, MgOₓ, TaOₓ, YOₓ, TiNₓ, CrNₓ, SiNₓ, AlNₓ, TaNₓ, SiCₓ, TiCₓ, and TaCₓ. x is a number larger than 0.

The material forming the grain boundary region can be either crystalline or amorphous.

The order of stacking of the hard magnetic recording layer and soft magnetic recording layer may also be reversed from that shown in FIG. 1 where necessary.

FIG. 2 is a graph showing typical magnetization curves of a comparative perpendicular magnetic recording layer having only a hard magnetic recording layer, i.e., including no soft magnetic recording layer, and having a residual squareness ratio of 1.

This example used a perpendicular magnetic recording medium formed by stacking, on a nonmagnetic glass substrate, a 100-nm thick Co₉₀Zr₅Nb₅ film as a soft magnetic underlayer, a 20-nm thick Ru film as a nonmagnetic underlayer, and a 20-nm thick (Co₇₆—Cr₆—Pt₁₈)-8 mol % SiO₂ film as a hard magnetic recording layer.

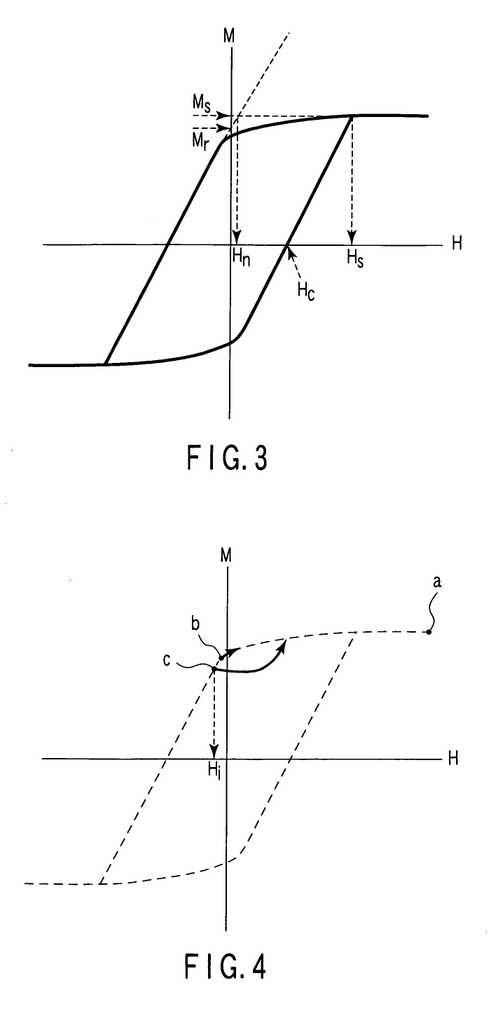

FIG. 3 is a graph showing magnetization curves of the perpendicular magnetic recording layer of the example of the perpendicular magnetic recording medium of the present invention.

This example used a perpendicular magnetic recording medium formed by stacking, on a nonmagnetic glass substrate, a 100-nm thick Co₉₀Zr₅Nb₅ film as a soft magnetic underlayer, a 20-nm thick Ru film as a nonmagnetic underlayer, a 20-nm thick (Co₇₆—Cr₆—Pt₁₈)-8 mol % SiO₂ film as a hard magnetic recording layer, and a 4-nm thick Co₅₀Ni₅₀-8 mol % SiO₂ film as a soft magnetic recording layer.

In FIGS. 2 and 3, reference symbols Ms and Mr respectively denote the saturation magnetization amount and residual magnetization amount, and reference symbols Hc, Hs, and Hn respectively denote the coercive force, saturation magnetic field, and nucleation magnetic field.

The magnetic recording layer of the perpendicular magnetic recording medium of the present invention has magnetic characteristics by which a magnetization curve obtained by applying a sufficiently large magnetic field perpendicularly to the film surface to saturate magnetization in the magnetic recording layer and measuring the relationship between the applied magnetic field and magnetization amount forms a hysteresis loop having a residual squareness ratio of 0.95 or less and an irreversible reversal magnetic field of 0 Oe or less. The residual squareness ratio Rs is the ratio Mr/Ms of the saturation magnetization amount Ms to the residual magnetization amount Mr. The irreversible reversal magnetic field is the magnitude of a magnetic field in which not only the magnetization rotating mechanism reversible to the applied magnetic field but also the magnetization reversing mechanism irreversible to the applied magnetic field is beginning to cause the magnetization process on the hysteresis loop.

The magnitude of the irreversible reversal magnetic field can be known by applying a sufficiently large magnetic field in the same manner as in the hysteresis loop measurement, folding back the loop by reversing the sweeping direction while the magnetic field is swept, and measuring the minor loop.

FIG. 4 is a graph showing schematic magnetization curves for explaining one definition of a term used in the present invention.

When the reversible magnetization rotating mechanism alone causes the magnetization process on the hysteresis loop, as schematically shown in FIG. 4, in a minor loop obtained by a path a→b→a, the folded magnetization curve reaches the point a by accurately tracing the original hysteresis loop (major loop). By contrast, when the magnetization process on the hysteresis loop includes the irreversible magnetization reversing mechanism, in a minor loop similarly obtained by a path a→c→a, the folded magnetization curve does not trace the major loop, and a hysteresis appears as shown in FIG. 4. A magnetic field in which the minor loop does not overlap the major loop and a hysteresis is beginning to appear is defined as the irreversible reversal magnetic field Hi.

If the magnetic recording layer is made of a single hard magnetic recording layer or two or more hard magnetic recording layers strongly coupled by exchange coupling, the magnetic recording layer almost coherently rotates and/or reverses magnetization in the direction of film thickness. In this case, the irreversible reversal magnetic field Hi matches the nucleation magnetic field Hn on the hysteresis loop shown in FIG. 2.

To obtain a high thermal decay resistance in the perpendicular magnetic recording medium, it is generally possible to set the irreversible reversal magnetic field to 0 or less. In the magnetic recording layer having the above structure, this is equivalent to setting the Hn to 0 or less, and this inevitably makes it possible to set the residual squareness ratio Rs to 1. On the other hand, to improve the writability, it is generally desirable to reduce the coercive force Hc and/or the saturation magnetic field Hs.

The coercive force Hc and/or the saturation magnetic field Hs can be reduced by reducing the crystal magnetic anisotropic energy of the magnetic crystal grains, or increasing the magnetic interaction between the magnetic crystal grains in the film surface. However, the thermal decay resistance decreases if the crystal magnetic anisotropic energy of the magnetic crystal grains is reduced, and the medium noise increases if the magnetic interaction between the magnetic crystal grains is increased. In the magnetic recording layer made of a single hard magnetic recording layer or two or more hard magnetic recording layers strongly coupled by exchange coupling, it is necessary to reduce the medium noise and recording magnetic field and increase the thermal decay resistance by using the two methods, i.e., the method of reducing the crystal magnetic anisotropic energy of the magnetic crystal grains, and the method of increasing the magnetic interaction between the magnetic crystal grains. However, the increase in recording density achieved by these methods has already reached its limit.

By contrast, the perpendicular magnetic recording medium of the present invention uses, as the perpendicular magnetic recording layer, the soft magnetic recording layer having a weak coercive force and small saturation magnetic field together with the hard magnetic recording layer having a high thermal decay resistance. In addition, the magnetic characteristics of the perpendicular magnetic recording layer are adjusted such that the residual squareness ratio is 0.95 or less and the value of the irreversible reversal magnetic field is 0 Oe or less on the hysteresis loop perpendicular to the film surface. It is possible by using this perpendicular magnetic recording layer to reduce the medium noise, improve the writability, and increase the thermal decay resistance at the same time.

The present invention achieves the magnetic characteristics by which the irreversible reversal magnetic field is 0 Oe or less, although the residual squareness ratio is less than 1. This is so presumably because when the exchange coupling force is “moderately” exerted between the magnetic crystal grains in the soft magnetic recording layer and the magnetic crystal grains in the hard magnetic recording layer, the two layers do not completely coherently reverse magnetization; prior to magnetization reversal in the hard magnetic recording layer, the soft magnetic recording layer can start reversible magnetization rotation before the applied magnetic field reaches the reversal magnetic field in the hard magnetic recording layer.

This magnetization reversing mechanism will be explained by taking the hysteresis loop shown in FIG. 4 as an example. In the magnetization process from the point a to the point b, only the soft magnetic recording layer having a weak coercive force starts reversible magnetization rotation. Then, after the point c (the irreversible reversal magnetic field), the hard magnetic recording layer having a strong coercive force starts magnetization reversal by receiving the assist of an exchange magnetic field acting between the hard magnetic recording layer and the soft magnetic recording layer during or after rotation. The soft magnetic recording layer can rotate magnetization reversibly to the applied magnetic field owing to the “moderate” exchange coupling force described above. Therefore, in the residual state (equivalent to the recorded state) after the applied magnetic field is removed, the magnetization in the soft magnetic layer can return to the same value as in the saturated state. Accordingly, even when the residual squareness ratio on the hysteresis loop is less than 1, the irreversible reversal magnetic field is 0 or less, so there is neither an adverse effect on the thermal decay resistance nor a decrease in reproduced output. Furthermore, when reversing the magnetization, the hard magnetic recording layer receives the assist of the exchange magnetic field acting between the hard magnetic recording layer and soft magnetic recording layer, in addition to the applied magnetic field and its own demagnetizing field. When compared to the case that the hard magnetic recording layer alone is used, therefore, magnetization reversal readily occurs with a low applied magnetic field, and the writability significantly improves.

As described above, when the magnetic recording layer having the hard magnetic recording layer and soft magnetic recording layer is used, the reversal magnetic field can be reduced without reducing the crystal magnetic anisotropic energy of the magnetic crystal grains and increasing the magnetic interaction between the magnetic crystal grains in the film surface, unlike when the magnetic recording layer made of the hard magnetic recording layer alone is used. This makes it possible to improve the writability, reduce the medium noise, and increase the thermal decay resistance at the same time.

The soft magnetic recording layer alone causes reversible magnetization rotation first probably because the exchange coupling force is moderately acting between the hard magnetic recording layer crystal grains and soft magnetic recording layer crystal grains. If the exchange coupling force is too strong, the soft magnetic recording layer and hard magnetic recording layer coherently cause magnetization reversal. This makes it impossible to increase the thermal decay resistance and reduce the noise at the same time as in the case that the hard magnetic recording layer alone is used. On the other hand, if the exchanging coupling is too weak, the soft magnetic recording layer causes irreversible magnetization reversal, and this makes it impossible to increase the thermal decay resistance and improve the writability at the same time. The magnetic characteristics and magnetization process mechanisms as described above are achieved by extensively studying the materials, film thicknesses, film formation methods, and the like of the hard and soft magnetic recording layers, and finding the optimum condition combinations.

Even when the magnetic recording layer having the soft magnetic recording layer stacked on the hard magnetic recording layer is used, a strong exchange coupling force acts between the hard magnetic crystal grains and soft magnetic crystal grains if the residual squareness ratio on the hysteresis loop is 1. As described previously, therefore, the magnetizations in the hard magnetic layer and soft magnetic layer coherently behave in the film thickness direction. This makes it impossible to obtain the effect of reducing the medium noise and recording magnetic field and increasing the thermal decay resistance at the same time, such as that of the perpendicular magnetic recording medium of the present invention.

Also, if no exchange coupling force acts between the magnetic crystal grains in the hard magnetic recording layer and the magnetic crystal grains in the soft magnetic recording layer, the soft magnetic recording layer and hard magnetic recording layer cause magnetization reversal completely independently of each other. If the soft magnetic recording layer causes irreversible magnetization reversal as described above as a result of this phenomenon, the irreversible reversal magnetic field cannot be 0 Oe or less, and the thermal decay resistance decreases. In addition, the magnetization in the soft magnetic recording layer freely behaves in the residual state (i.e., the recorded state), thereby increasing the medium noise and decreasing the SNR. This makes it impossible to obtain the effect of the perpendicular magnetic recording medium of the present invention as described above.

The coercive force of the magnetic recording layer can be set within the range of 2.5 to 7 kOe, preferably, 3 to 5.5 kOe. If the coercive force is less than 2.5 kOe, the SNR often decreases. If the coercive force exceeds 7 kOe, the writability often deteriorates.

The residual squareness ratio of the perpendicular magnetic recording layer of the perpendicular magnetic recording medium of the present invention can be set within the range of 0.7 to 0.9, preferably, 0.8 to 0.9. If the residual squareness ratio is less than 0.7, the writability often deteriorates. If the residual squareness ratio exceeds 0.9, the SNR often decreases.

The irreversible reversal magnetic field can be set within the range of −3.5 to −0.5 kOe, preferably, −3 to −1 kOe. If the irreversible reversal magnetic field is less than −0.5 kOe, the thermal decay resistance often decreases. If the irreversible reversal magnetic field exceeds −3.5 kOe, the writability often deteriorates.

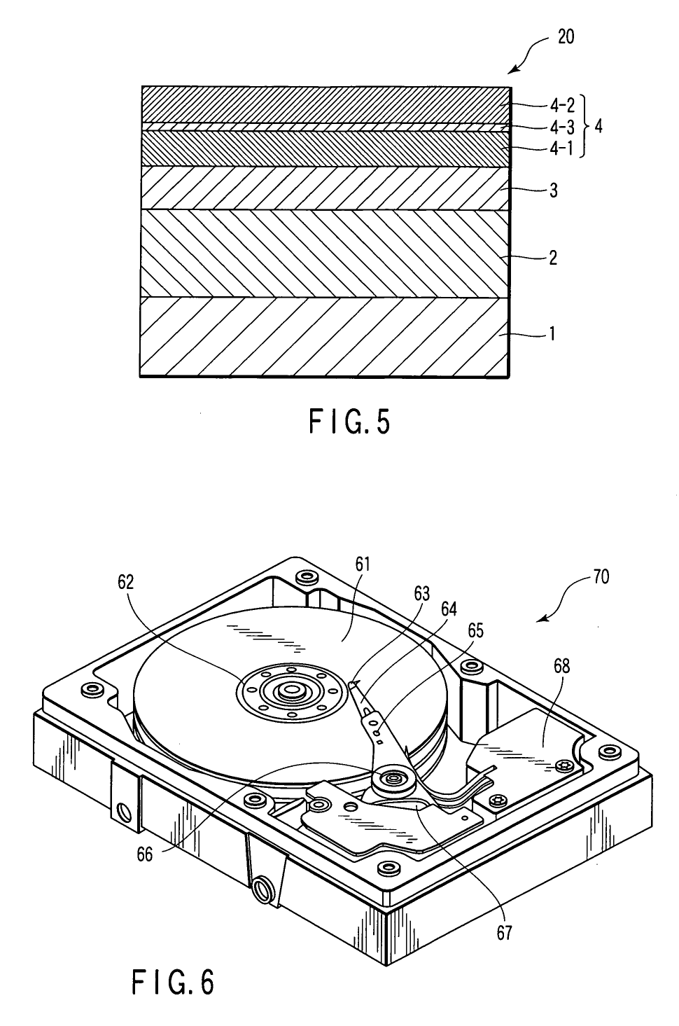

FIG. 5 is a sectional view showing another example of the perpendicular magnetic recording medium according to the present invention.

As shown in FIG. 5, a perpendicular magnetic recording medium 20 has a stacked structure in which a soft magnetic underlayer 2, nonmagnetic underlayer 3, and perpendicular magnetic recording layer 4 are sequentially stacked on a substrate 1. The perpendicular magnetic recording layer 4 has three sequentially stacked layers, i.e., a hard magnetic recording layer 4-1, nonmagnetic interlayer 4-3, and soft magnetic recording layer 4-2.

The exchange coupling force between the hard magnetic recording layer and soft magnetic recording layer can be further optimally adjusted by forming the thin nonmagnetic interlayer between them.

The film thickness of the nonmagnetic interlayer can be 0.3 to 1.5 nm, preferably, 0.5 to 1 nm. If the nonmagnetic interlayer film thickness is less than 0.3 nm, it is difficult to form a continuous film and obtain a notable effect of controlling the magnetic characteristics. If the nonmagnetic interlayer film thickness exceeds 2 nm, the exchange coupling significantly weakens, and the soft magnetic recording layer often causes irreversible magnetization reversal.

The film thickness of the nonmagnetic interlayer can be evaluated by, e.g., sectional TEM observation.

As the nonmagnetic interlayer material, it is possible to use a metal or alloy containing at least one of Pd, Pt, Cu, Ti, Ru, Re, Ir, and Cr.

When the nonmagnetic interlayer has the granular structure, magnetic isolation of the hard magnetic recording layer or soft magnetic recording layer stacked on the nonmagnetic interlayer accelerates, so the SNR can further increase. As the material forming the grain boundary region of the nonmagnetic interlayer, a compound such as an oxide, nitride, or carbide can be used. These compounds readily deposit because they hardly form any solid solution with the nonmagnetic crystal grain materials described above. Practical examples of the material forming the grain boundary region of the nonmagnetic interlayer are SiOₓ, TiOₓ, CrOₓ, AlOₓ, MgOₓ, TaOₓ, YOₓ, TiNₓ, CrNₓ, SiNₓ, AlNₓ, TaNₓ, SiCₓ, TiCₓ, and TaCₓ.

The material forming the grain boundary region can be either crystalline or amorphous.

As the nonmagnetic underlayer of the perpendicular magnetic recording medium of the present invention, it is possible to use a metal or alloy containing at least one of Ru, Ti, Pt, and Re. For example, the material is selected from Ru, Ti, Re, and a Pt—Cr alloy. These materials have high lattice matching with the magnetic crystal grains in the hard magnetic recording layer described earlier, and can improve the (0001) orientation of the magnetic crystal grains.

To improve the crystal orientation of the nonmagnetic underlayer, a seed layer can be formed between the soft magnetic underlayer and nonmagnetic underlayer. Practical examples are Pd, Pt, Ta, Ni—Ta, Ni—Nb, Ni—Zr, Ni—Fe—Cr, and Ni—Fe.

A so-called perpendicular double-layered medium is obtained by forming a soft under layer with high magnetic permeability between the nonmagnetic underlayer and substrate. In this perpendicular double-layered medium, the soft magnetic underlayer is longitudinally orientated. The soft magnetic underlayer horizontally passes a recording magnetic field from a magnetic head, e.g., a single-pole head for magnetizing the perpendicular magnetic recording layer, and returns the magnetic field to the magnetic head. That is, the soft magnetic underlayer performs part of the function of the magnetic head. The soft magnetic underlayer can apply a steep, sufficient perpendicular magnetic field to the magnetic field recording layer, thereby increasing the recording/reproduction efficiency.

Examples of the soft magnetic layer as described above are CoZrNb, CoB, CoTaZr, FeSiAl, FeTaC, CoTaC, NiFe, Fe, FeCoB, FeCoN, FeTaN, and CoIr.

The soft magnetic underlayer may also be a multilayered film having two or more layers. In this case, the materials, compositions, and film thicknesses of the individual layers can be different. It is also possible to form a triple-layered structure by stacking two soft magnetic underlayers with a thin Ru layer being sandwiched between them.

Furthermore, a bias application layer such as a longitudinal hard magnetic film or antiferromagnetic film can be formed between the soft magnetic underlayer and substrate. The soft magnetic layer easily forms a magnetic domain, and this magnetic domain produces spike noise. Therefore, by applying a magnetic field in one direction along the radial direction of the bias application layer, it is possible to apply a biasing magnetic field to the soft magnetic layer formed on the bias application layer, thereby preventing the generation of a magnetic wall. It is also possible to finely disperse anisotropy by giving the bias application layer a stacked structure, thereby preventing easy formation of a large magnetic domain. Examples of the bias application layer material are CoCrPt, CoCrPtB, CoCrPtTa, CoCrPtTaNd, CoSm, CoPt, FePt, CoPtO, CoPtCrO, CoPt—SiO₂, CoCrPt—SiO₂, CoCrPtO—SiO₂, FeMn, IrMn, and PtMn.

As the nonmagnetic substrate, it is possible to use, e.g., a glass substrate, an Al-based alloy substrate, an Si single-crystal substrate having an oxidized surface, ceramics, or plastic. The same effect can be expected even when the surface of any of these nonmagnetic substrates is plated with an NiP alloy or the like. A protective layer can be formed on the magnetic recording layer. Examples of the protective layer are C, diamond-like carbon (DLC), SiNₓ, SiOₓ, and CNₓ.

As methods of forming the individual layers, it is possible to use vacuum vapor deposition, various sputtering methods, molecular beam epitaxy, ion beam vapor deposition, laser abrasion, and chemical vapor deposition.

FIG. 6 is a partially exploded perspective view of an example of the magnetic recording/reproducing apparatus of the present invention.

In a magnetic recording/reproducing apparatus 70, a rigid magnetic disk 61 for recording information according to the present invention is mounted on a spindle 62, and rotated at a predetermined rotational speed by a spindle motor (not shown). A slider 63 on which a recording head for recording information by accessing the magnetic disk 61 and an MR head for reproducing information are mounted is fixed to the distal end of a suspension 64 made of a thin leaf spring. The suspension 64 is connected to one end of an arm 65 having, e.g., a bobbin that holds a driving coil (not shown).

A voice coil motor 66 as a kind of a linear motor is formed at the other end of the arm 65. The voice coil motor 66 comprises the driving coil (not shown) wound on the bobbin of the arm 65, and a magnetic circuit including a permanent magnet and counter yoke opposing each other so as to sandwich the driving coil.

Ball bearings (not shown) formed in the upper and lower portions of a fixing shaft 67 hold the arm 65, and the voice coil motor 66 pivots the arm 65. That is, the voice coil motor 66 controls the position of the slider 63 on the magnetic disk 61. Note that reference numeral 68 in FIG. 6 denotes a lid.

### EXAMPLES

The present invention will be explained in more detail below by way of its examples.

### Example 1

A 2.5-inch hard disk type nonmagnetic glass substrate (TS-10SX manufactured by OHARA) was placed in a vacuum chamber of the c-3010 sputtering apparatus manufactured by ANELVA.

After the vacuum chamber of the sputtering apparatus was evacuated to 1×10⁻⁵ Pa or less, a 100-nm thick Co₉₀Zr₅Nb₅ film as a soft magnetic underlayer, a 20-nm thick Ru film as a nonmagnetic underlayer, a 20-nm thick (Co₇₆—Cr₆—Pt₁₈)-8 mol % SiO₂ film as a hard magnetic recording layer, a Co₃₅Ni₆₅-8 mol % SiO₂ film as a soft magnetic recording layer, and a 5-nm thick C film as a protective layer were sequentially formed. The film thickness of the soft magnetic recording layer was changed within the range of 1 to 20 nm. After the film formation, the surface of the protective layer was coated with a 13-Å thick perfluoropolyether (PFPE) lubricant by dipping, thereby obtaining perpendicular magnetic recording media.

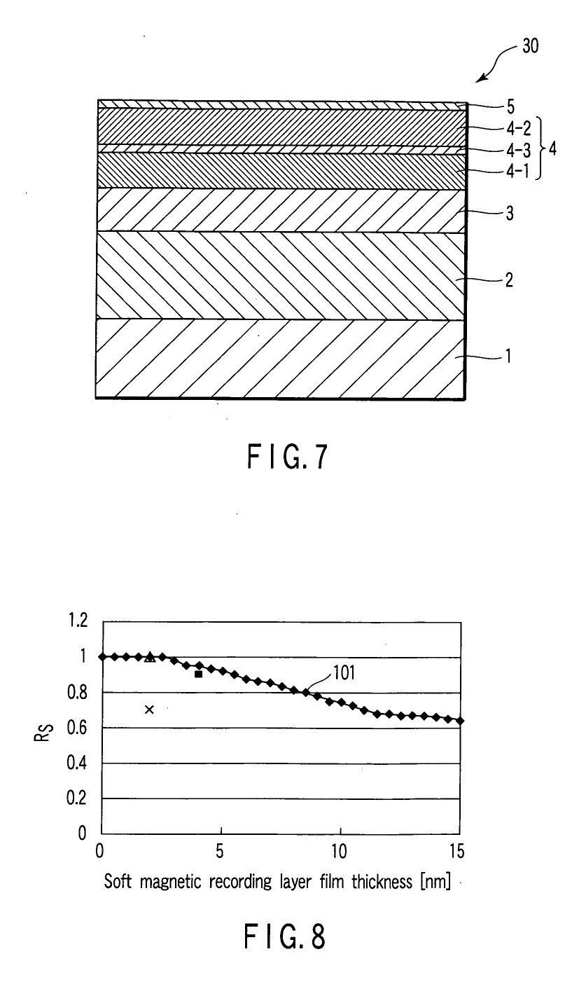

FIG. 7 is a view schematically showing the section of the perpendicular magnetic recording medium according to Example 1.

As shown in FIG. 7, this perpendicular magnetic recording medium had the same structure as shown in FIG. 5 except that a protective layer 5 was formed on a soft magnetic recording layer 4-2.

When forming the films of Co₉₀Zr₅Nb₅, Ru, (Co₇₆—Cr₆—Pt₁₈)-8 mol % SiO₂, Co₃₅Ni₆₅-8 mol % SiO₂, and C, the Ar pressures were respectively 0.7, 5, 5, 0.7, and 0.7 Pa, the targets used were respectively Co₉₀Zr₅Nb₅, Ru, (Co₇₆—Cr₆—Pt₁₈)-8 mol % SiO₂, Co₃₅Ni₆₅-8 mol % SiO₂, and C targets each having a diameter of 164 mm, and the films were formed by DC sputtering. The input power to each target was 1,000 W. The distance between the target and substrate was 50 mm, and all the films were formed at room temperature.

### Comparative Example 1

As a comparative example, a conventional perpendicular magnetic recording medium was manufactured following the same procedures as in Example 1 except that no soft magnetic recording layer was formed.

### Comparative Example 2

As a comparative example, a perpendicular magnetic recording medium in which a soft magnetic recording layer had no granular structure was manufactured as follows.

That is, the perpendicular magnetic recording medium was manufactured following the same procedures as in Example 1 except that the soft magnetic recording layer was made of Co₃₅Ni₆₅ and had a film thickness fixed to 4 nm.

### Comparative Example 3

As a comparative example, perpendicular magnetic recording media in which a soft magnetic recording layer was strongly coupled on a hard magnetic recording layer by exchange coupling and the residual squareness ratio on the hysteresis loop was 1 were manufactured as follows.

A 2.5-inch hard disk type nonmagnetic glass substrate (TS-10SX manufactured by OHARA) was placed in a vacuum chamber of the c-3010 sputtering apparatus manufactured by ANELVA.

After the vacuum chamber of the sputtering apparatus was evacuated to 1×10⁻⁵ Pa or less, a 100-nm thick Co₈₉Zr₄Nb₇ film was formed as a soft magnetic underlayer at a substrate temperature of 100° C. After that, at a substrate temperature of 200° C., an 8-nm thick Ni₅₀—Al₅₀ film as nonmagnetic underlayer 1, a 20-nm thick Ru film as nonmagnetic underlayer 2, a 30-nm thick Co₆₂—Cr₂₀—Pt₁₄—B₄ film as a hard magnetic recording layer, a 2-nm thick Co₈₉Zr₄Nb₇ film as a soft magnetic recording layer, and a 5-nm thick C film as a protective layer were sequentially formed on the soft magnetic underlayer. After the film formation, the surface of the protective layer was coated with a 13-Å thick perfluoropolyether (PFPE) lubricant by dipping, thereby obtaining the perpendicular magnetic recording media.

When forming the films of Co₈₉Zr₄Nb₇, Ni₅₀—Al₅₀, Ru, Co₆₂—Cr₂₀—Pt₁₄—B₄, Co₈₉Zr₄Nb₇, and C, all the Ar pressures were 0.5 Pa, the targets used were respectively Co₈₉Zr₄Nb₇, Ni₅₀—Al₅₀, Ru, Co₆₂—Cr₂₀—Pt₁₄—B₄, Co₈₉Zr₄Nb₇, and C targets each having a diameter of 164 mm, and the films were formed by DC sputtering. The input power to all the targets was 1,000 W. The distance between the target and substrate was 50 mm.

### Comparative Example 4

As a comparative example, a perpendicular magnetic recording medium in which there was no exchange coupling between a hard magnetic recording layer and soft magnetic recording layer and the irreversible reversal magnetic field was not 0 Oe or less was manufactured as follows.

That is, after films were sequentially formed up to a hard magnetic recording layer following the same procedure as in Comparative Example 3, a 10-nm thick Ru film was formed as a nonmagnetic interlayer on the hard magnetic recording layer in order to avoid exchange coupling. After that, a soft magnetic recording layer, protective layer, and lubricant were sequentially stacked following the same procedure as in Example 3, thereby obtaining the perpendicular magnetic recording medium.

The microstructure of each obtained perpendicular magnetic recording medium was evaluated by using a TEM having an acceleration voltage of 400 kV.

The hysteresis loop and minor loop perpendicular to the film surface of the perpendicular magnetic recording layer of each perpendicular magnetic recording medium were evaluated by a Kerr effect evaluating apparatus by using a laser source having a wavelength of 300 nm, under the conditions that the maximum applied magnetic field was 20 kOe and the magnetic field sweeping rate was 133 Oe/sec.

Each perpendicular magnetic recording medium was caused to generate Cu—K α-rays by using the X'pert-MRD X-ray diffraction apparatus manufactured by Philips, under the conditions that the acceleration voltage was 45 kV and the filament electric current was 40 mA, and the crystal structure and crystal plane orientation were evaluated by the θ-2θ method.

The R/W characteristics of each perpendicular magnetic recording medium were evaluated by using a spin stand. As a magnetic head, a combination of a single-pole head having a recording track width of 0.3 μm and an MR head having a reproducing track width of 0.2 μm was used.

The measurements were performed in a radial position of 20 mm, i.e., in a fixed position by rotating the disk at 4,200 rpm.

As the medium SNR, the value of the signal-to-noise ratio (SNRm) (S was the output at a linear recording density of 119 kfci, and Nm was the value of rms (root mean square) at 716 kfci) of a differential waveform obtained through a differentiating circuit.

The medium OW characteristic was evaluated by recording a 119-kfci signal, overwriting a 250-kfci signal, and measuring the reproduced output ratio (attenuation ratio) of the 119-kfci signals before and after the overwrite.

The medium thermal decay resistance was evaluated in an environment at a temperature of 70° C. by recording a 100-kfci signal, and measuring the ratio V1000/V0 of the reproduced output of the 100 kfci signal immediately after it was recorded to that after the signal was left to stand for 1,000 sec.

The results of the XRD evaluation showed that the magnetic crystal grains in the hard magnetic recording layer of any perpendicular magnetic recording medium had the hcp structure and were orientated in the (0001) plane.

The results of the planar TEM observation indicated that the hard magnetic recording layer of any perpendicular magnetic recording medium had the granular structure in which the grain boundary region surrounded the magnetic crystal grains. The average grain size of the magnetic crystal grains in Example 1 and Comparative Examples 1 and 2 was 7.8 nm. Also, the results of the composition analysis by TEM-EDX revealed that the magnetic crystal grains in Example 1 and Comparative Examples 1 and 2 contained Co, Pt, and Cr.

Furthermore, the soft magnetic recording layer of the perpendicular magnetic recording medium of Example 1 had the granular structure in which the grain boundary region surrounded the magnetic crystal grains, similar to the hard magnetic recording layer. The average grain size of the magnetic crystal grains was 7.1 nm. On the other hand, the soft magnetic recording layers of the perpendicular magnetic recording media of Comparative Examples 2, 3 and 4 were continuous films having no granular structure.

FIGS. 8, 9, and 10 are graphs showing the relationships between the soft magnetic recording layer film thickness of the perpendicular magnetic recording medium according to Example 1 and the residual squareness ratio Rs, irreversible reversal magnetic field Hi, and coercive force Hc as curves 101, 102, and 103, respectively.

Referring to FIGS. 8 to 10, a point where the soft magnetic recording layer film thickness is 0 nm indicates the value of the perpendicular magnetic recording medium of Comparative Example 1. For comparison, symbols ▪, Δ, and × respectively indicate Comparative Examples 2, 3, and 4.

FIGS. 8 to 10 demonstrate that the Rs and Hc monotonously decreased and the Hi monotonously increased with the soft magnetic recording layer film thickness.

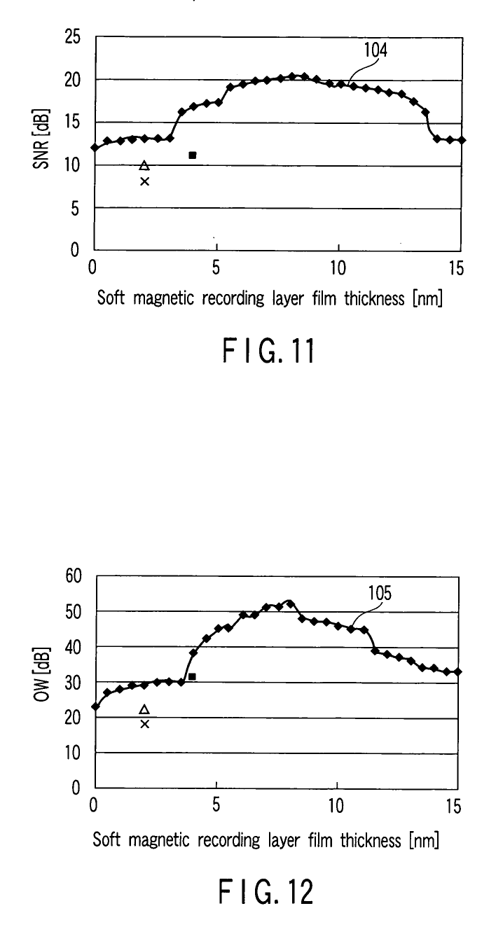

FIGS. 11, 12, and 13 are graphs showing the relationships between the soft magnetic recording layer film thickness of the perpendicular magnetic recording medium of Example 1 and the SNR, OW, and V1000/V0 by curves 104, 105, and 106, respectively. Referring to FIGS. 11 to 13, a point where the soft magnetic recording layer film thickness is 0 nm indicates the value of the perpendicular magnetic recording medium of Comparative Example 1. For comparison, symbols ▪, Δ, and × respectively indicate Comparative Examples 2, 3, and 4.

A comparison of FIG. 8 with FIG. 11 reveals that the SNR of Example 1 remarkably increased when the Rs was 0.95 or less.

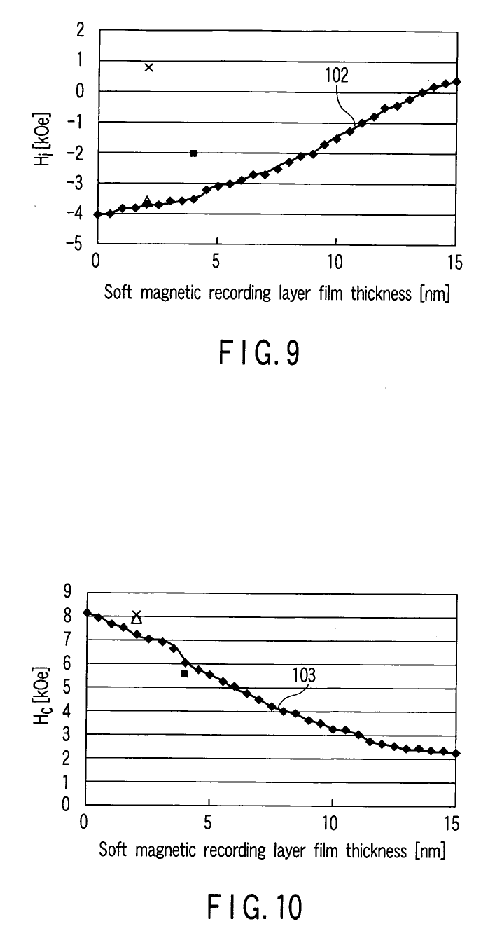

A comparison of FIG. 9 with FIG. 12 shows that the thermal decay resistance was high when the Hi was 0 Oe or less.

Comparing FIG. 10 with FIG. 12 indicates that the 0 W characteristic significantly improved when the Hc was 7 kOe or less. Also, comparing FIG. 10 with FIG. 11 shows that the SNR significantly increased when the Hc was 2.5 kOe or more.

A comparison of FIGS. 8 and 11 demonstrates that the increase in SNR was further notable when the Rs was 0.9 or less. A comparison of FIGS. 8 and 12 indicates that the OW characteristic was favorable when the Rs was 0.7 or more.

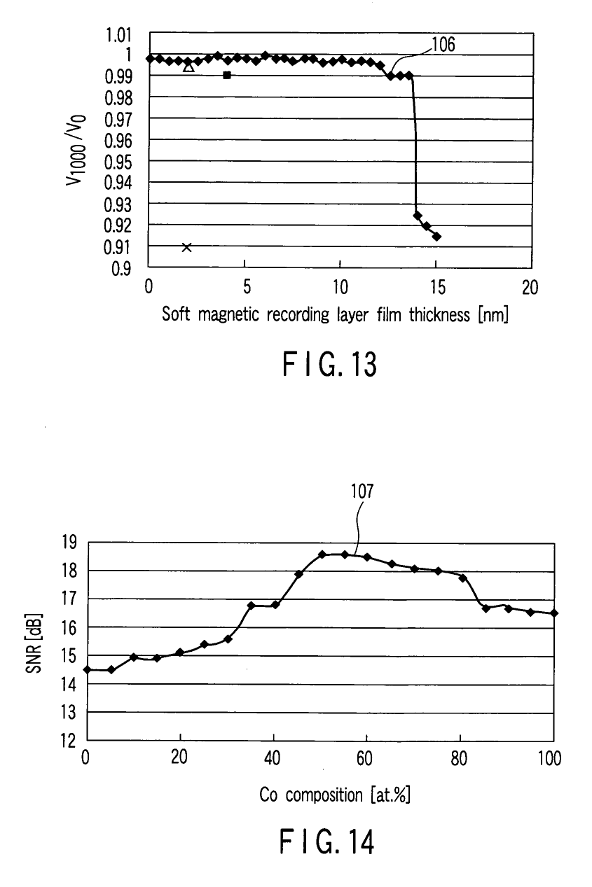

Comparing FIG. 9 with FIG. 12 reveals that the 0 W characteristic significantly improved when the Hi was −3.5 kOe or more. On the other hand, a comparison of FIG. 9 with FIG. 13 shows that the thermal decay resistance further increased when the Hi was −0.5 kOe or less.

FIG. 8 shows that the Rs of the perpendicular magnetic recording medium of Comparative Example 3 was 1. This reveals that the hard magnetic recording layer and soft magnetic recording layer strongly coupled with each other by exchange coupling, and coherently reversed magnetization. Also, the Hi of the perpendicular magnetic recording medium of Comparative Example 4 was larger than 0 Oe.

FIGS. 8, 9, 11, and 12 demonstrate that the perpendicular magnetic recording medium of Example 1 in which the Rs was 0.95 or less and the Hi was 0 Oe or less was superior in SNR and OW characteristic to the perpendicular magnetic recording medium of Comparative Example 1.

FIGS. 8, 9, and 11 indicate that the perpendicular magnetic recording medium of Example 1 in which the Rs was 0.95 or less and the Hi was 0 Oe or less had an SNR higher than that of the perpendicular magnetic recording medium of Comparative Example 2.

FIGS. 8, 9, 11, and 12 show that the perpendicular magnetic recording medium of Example 1 in which the Rs was 0.95 or less and the Hi was 0 Oe or less was superior in SNR and OW characteristic to the perpendicular magnetic recording medium of Comparative Example 3.

FIGS. 8, 9, 11, and 12 reveal that the perpendicular magnetic recording medium of Example 1 in which the Rs was 0.95 or less and the Hi was 0 Oe or less was superior in SNR, OW characteristic, and thermal decay resistance to the perpendicular magnetic recording medium of Comparative Example 4.

### Example 2

Perpendicular magnetic recording media were manufactured following the same procedures as in Example 1 except that any of Fe—Ni-8 mol % SiO₂, Co—Ni-8 mol % SiO₂, and Fe—Co-8 mol % SiO₂ was used as a soft magnetic recording layer instead of the 20-nm thick (Co₇₆—Cr₆—Pt₁₈)-8 mol % SiO₂ film, and the composition ratios of these Fe—Ni, Co—Ni, and Fe—Co alloys were changed. The soft magnetic recording layer film thickness was fixed to 4 nm.

Each alloy composition was changed by adjusting the target alloy composition.

The results of the XRD evaluation showed that the magnetic crystal grains in the hard magnetic recording layer of any perpendicular magnetic recording medium had the hcp structure and were orientated in the (0001) plane.

The results of the planar TEM observation indicated that the hard magnetic recording layer of any perpendicular magnetic recording medium had the granular structure in which the grain boundary region surrounded the magnetic crystal grains. Also, the results of the composition analysis by TEM-EDX revealed that the magnetic crystal grains contained Co, Pt, and Cr.

Furthermore, the soft magnetic recording layer of any perpendicular magnetic recording medium had the granular structure in which the grain boundary region surrounded the magnetic crystal grains, similar to the hard magnetic recording layer.

Table 1 below shows the values of the medium SNR, OW, and thermal decay resistance when the soft magnetic recording layers were made of Fe₃₅—Ni₆₅-8 mol % SiO₂, Co₃₅—Ni₆₅-8 mol % SiO₂, Co₆₅—Fe₃₅-8 mol % SiO₂, Fe—SiO₂, and Co—SiO₂.

TABLE 1

| Soft magnetic | | Hi | | SNR | OW | |
|---|---|---|---|---|---|---|
| recording layer | Rs | [kOe] | Hc [kOe] | [dB] | [dB] | V1000/V0 |
| None | 1.0 | −4.0 | 8.1 | 12.0 | 23 | 0.998 |
| Co₃₅Ni₆₅—8% SiO₂ | 0.95 | −3.5 | 7.0 | 16.8 | 38 | 0.997 |
| Fe₃₅Ni₆₅—8% SiO₂ | 0.91 | −2.8 | 5.4 | 16.6 | 40 | 0.996 |
| Fe₅₀Co₅₀—8% SiO₂ | 0.87 | −2.1 | 4.8 | 16.5 | 43 | 0.995 |
| Fe—8% SiO₂ | 0.84 | −1.7 | 4.2 | 16.5 | 46 | 0.992 |
| Co—8% SiO₂ | 0.89 | −2.3 | 5.0 | 16.6 | 42 | 0.996 |

Table 1 reveals that when any of Fe, Co, and the Fe—Ni, Co—Ni, and Fe—Co alloys was used as the magnetic crystal grains in the soft magnetic recording layer, the medium SNR and OW significantly improved and the thermal decay resistance also increased even when the soft magnetic recording layer film thickness was as small as 4 nm.

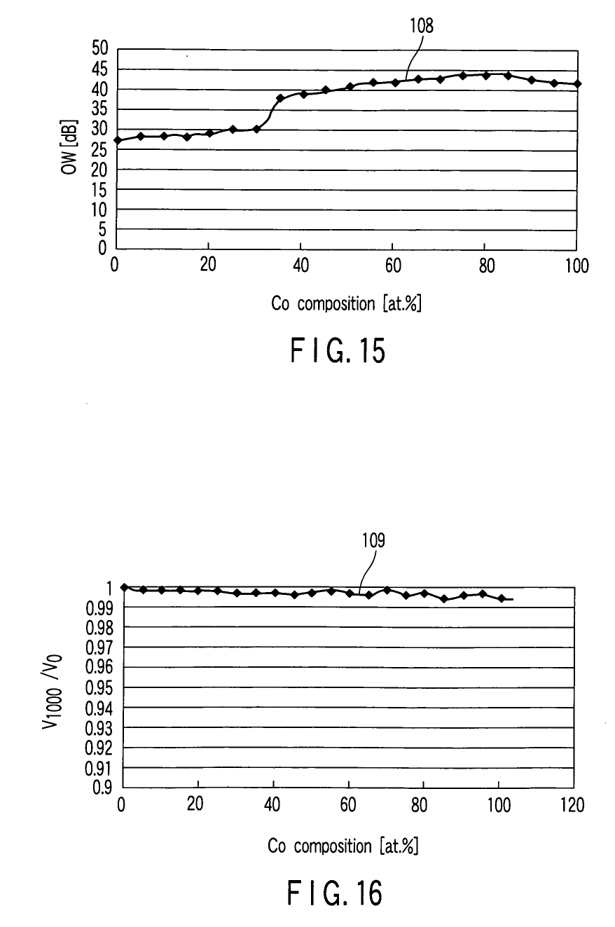

FIGS. 14, 15, and 16 are graphs showing the changes in medium SNR, OW, and thermal decay resistance with respect to the Co composition when the soft magnetic recording layer was made of CoNi—SiO₂, as curves 107, 108, and 109, respectively. FIGS. 14 to 16 demonstrate that the SNR remarkably increased when the Co composition was 45% to 80%.

### Example 3

Perpendicular magnetic recording media were manufactured following the same procedures as in Example 1 except that a hard magnetic recording layer was made of (Co₇₆—Cr₈—Pt₁₆)-8 mol % TiO or (Co₇₆—Cr₈—Pt₁₆)-8 mol % Cr₂O₃, a soft magnetic recording layer was made of any of Co₅₀—Ni₅₀-8 mol % TiO, Co₅₀Ni₅₀-8 mol % Cr₂O₃, Co₅₀Ni₅₀-8 mol % Y₂O₃, Co₅₀Ni₅₀-8 mol % MgO, Co₅₀Ni₅₀-8 mol % Al₂O₃, and Co₅₀Ni₅₀-8 mol % Ta₂O₅, and the soft magnetic recording layer film thickness was fixed to 4 nm.

The layers made of (Co₇₆—Cr₈—Pt₁₆)-8 mol % TiO, (Co₇₆—Cr₈—Pt₁₆)-8 mol % Cr₂O₃, Co₅₀—Ni₅₀-8 mol % TiO, Co₅₀Ni₅₀-8 mol % Cr₂O_{3,} Co₅₀Ni₅₀-8 mol % Y₂O₃, Co₅₀Ni₅₀-8 mol % MgO, Co₅₀Ni₅₀-8 mol % Al₂O₃, and Co₅₀Ni₅₀-8 mol % Ta₂O₅ were respectively formed by using targets made of (Co₇₆—Cr₈—Pt₁₆)-8 mol % TiO, (Co₇₆—Cr₈—Pt₁₆)-8 mol % Cr₂O₃, Co₅₀—Ni₅₀-8 mol % TiO, Co₅₀Ni₅₀-8 mol % Cr₂O₃, Co₅₀Ni₅₀-8 mol % Y₂O₃, Co₅₀Ni₅₀-8 mol % MgO, Co₅₀Ni₅₀-8 mol % Al₂O₃, and Co₅₀Ni₅₀-8 mol % Ta₂O₅ each having a diameter of 164 mm.

The results of the XRD evaluation showed that the magnetic crystal grains in the hard magnetic recording layer of any perpendicular magnetic recording medium had the hcp structure and were orientated in the (0001) plane.

The results of the planar TEM observation indicated that the hard magnetic recording layer of any perpendicular magnetic recording medium had the granular structure in which the grain boundary region surrounded the magnetic crystal grains. Also, the results of the composition analysis by TEM-EDX revealed that the magnetic crystal grains contained Co, Pt, and Cr.

Furthermore, the soft magnetic recording layer of any perpendicular magnetic recording medium had the granular structure in which the grain boundary region surrounded the magnetic crystal grains, similar to the hard magnetic recording layer.

Table 2 below show the residual squareness ratio Rs, irreversible reversal magnetic field Hi, coercive force Hc, medium SNR, OW, and thermal decay resistance of each perpendicular magnetic recording medium.

TABLE 2

| Hard magnetic | Soft magnetic | | | | | | |
|---|---|---|---|---|---|---|---|
| recording layer | recording layer | Rs | Hi [kOe] | Hc [kOe] | SNR [dB] | OW [dB] | V1000/V0 |
| CoCrPt—SiO₂ | None | 1.0 | −4.0 | 8.1 | 12.0 | 23 | 0.998 |
| CoCrPt—SiO₂ | CoNi—SiO₂ | 0.82 | −2.5 | 6.1 | 18.6 | 41 | 0.997 |
| CoCrPt—SiO₂ | CoNi—TiO | 0.85 | −2.6 | 6.0 | 18.9 | 41 | 0.998 |
| CoCrPt—SiO₂ | CoNi—Cr₂O₃ | 0.86 | −2.4 | 6.1 | 18.5 | 42 | 0.999 |
| CoCrPt—SiO₂ | CoNi—MgO | 0.86 | −2.4 | 6.2 | 18.4 | 43 | 0.999 |
| CoCrPt—SiO₂ | CoNi—Y₂O₃ | 0.88 | −2.7 | 6.0 | 18.3 | 42 | 0.999 |
| CoCrPt—SiO₂ | CoNi—Al₂O₃ | 0.87 | −2.7 | 6.1 | 18.3 | 43 | 0.999 |
| CoCrPt—SiO₂ | CoNi—Ta₂O₅ | 0.86 | −2.8 | 6.1 | 18.4 | 43 | 0.997 |
| CoCrPt—TiO | None | 1.0 | −4.1 | 7.9 | 12.2 | 23 | 0.999 |
| CoCrPt—TiO | CoNi—SiO₂ | 0.82 | −2.6 | 5.9 | 18.8 | 42 | 0.997 |
| CoCrPt—TiO | CoNi—TiO | 0.83 | −2.6 | 5.9 | 19.0 | 41 | 0.997 |
| CoCrPt—TiO | CoNi—Cr₂O₃ | 0.86 | −2.6 | 6.0 | 18.7 | 43 | 0.998 |
| CoCrPt—TiO | CoNi—MgO | 0.87 | −2.5 | 5.7 | 18.8 | 43 | 0.997 |
| CoCrPt—TiO | CoNi—Y₂O₃ | 0.84 | −2.4 | 5.7 | 18.6 | 44 | 0.999 |
| CoCrPt—TiO | CoNi—Al₂O₃ | 0.84 | −2.4 | 5.6 | 18.7 | 44 | 0.998 |
| CoCrPt—TiO | CoNi—Ta₂O₅ | 0.88 | −2.7 | 5.7 | 18.7 | 43 | 0.999 |
| CoCrPt—Cr₂O₃ | None | 1.0 | −3.8 | 7.7 | 12.0 | 23 | 0.998 |
| CoCrPt—Cr₂O₃ | CoNi—SiO₂ | 0.84 | −2.2 | 5.7 | 18.5 | 45 | 0.996 |
| CoCrPt—Cr₂O₃ | CoNi—TiO | 0.86 | −2.4 | 5.6 | 18.6 | 44 | 0.996 |
| CoCrPt—Cr₂O₃ | CoNi—Cr₂O₃ | 0.86 | −2.3 | 5.6 | 18.4 | 46 | 0.997 |
| CoCrPt—Cr₂O₃ | CoNi—MgO | 0.85 | −2.3 | 5.7 | 18.3 | 47 | 0.999 |
| CoCrPt—Cr₂O₃ | CoNi—Y₂O₃ | 0.88 | −2.5 | 5.6 | 18.3 | 47 | 0.999 |
| CoCrPt—Cr₂O₃ | CoNi—Al₂O₃ | 0.87 | −2.4 | 5.7 | 18.3 | 47 | 0.998 |
| CoCrPt—Cr₂O₃ | CoNi—Ta₂O₅ | 0.87 | −2.4 | 5.9 | 18.4 | 46 | 0.999 |

Table 2 reveal that each medium had a high SNR, a good OW characteristic, and a high thermal decay resistance.

### Example 4

Perpendicular magnetic recording media were manufactured following the same procedures as in Example 1 except that a Pd film having a thickness of 0.1 to 3 nm was formed as a nonmagnetic interlayer between a hard magnetic recording layer and soft magnetic recording layer, and a 4-nm thick Co₅₀Ni₅₀-8 mol % SiO₂ film was formed as the soft magnetic recording layer. The Pd interlayer was formed by DC sputtering by using a Pd target 164 mm in diameter at an Ar pressure of 0.7 Pa and an input power of 100 W.

The results of the XRD evaluation showed that the magnetic crystal grains in the hard magnetic recording layer of any perpendicular magnetic recording medium had the hcp structure and were orientated in the (0001) plane.

The results of the planar TEM observation indicated that the hard magnetic recording layer of any perpendicular magnetic recording medium had the granular structure in which the grain boundary region surrounded the magnetic crystal grains. Also, the results of the composition analysis by TEM-EDX revealed that the magnetic crystal grains contained Co, Pt, and Cr.

Furthermore, the soft magnetic recording layer of every perpendicular magnetic recording medium had the granular structure in which the grain boundary region surrounded the magnetic crystal grains, similar to the hard magnetic recording layer. On the other hand, none of the nonmagnetic interlayers had the granular structure.

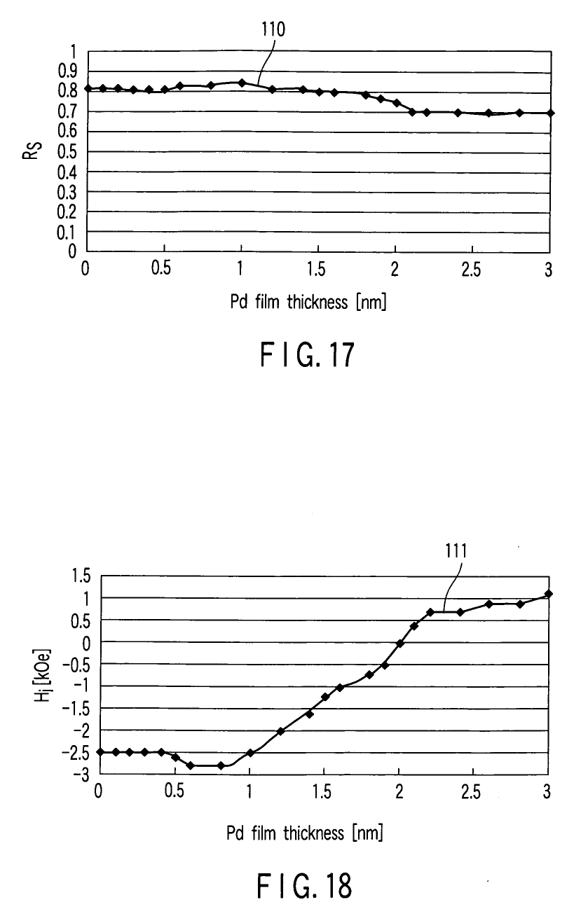

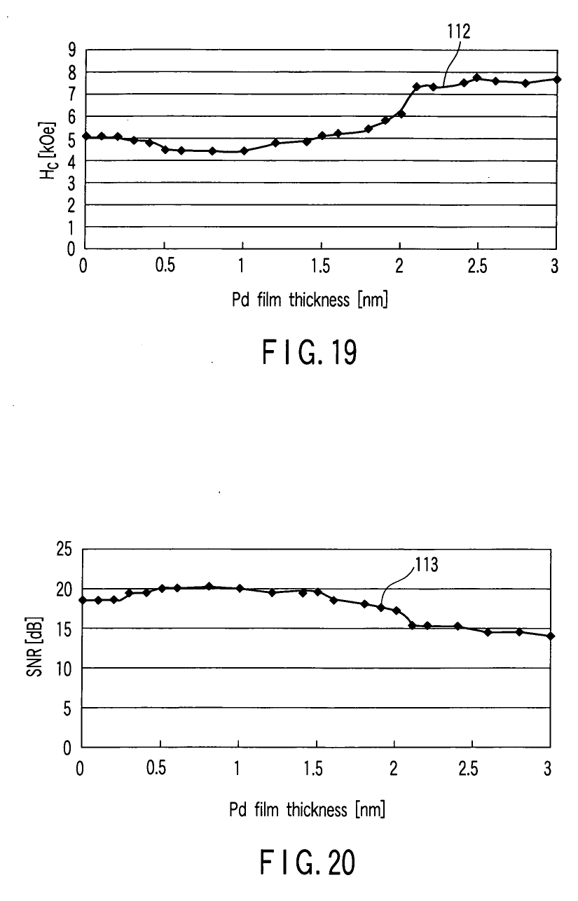

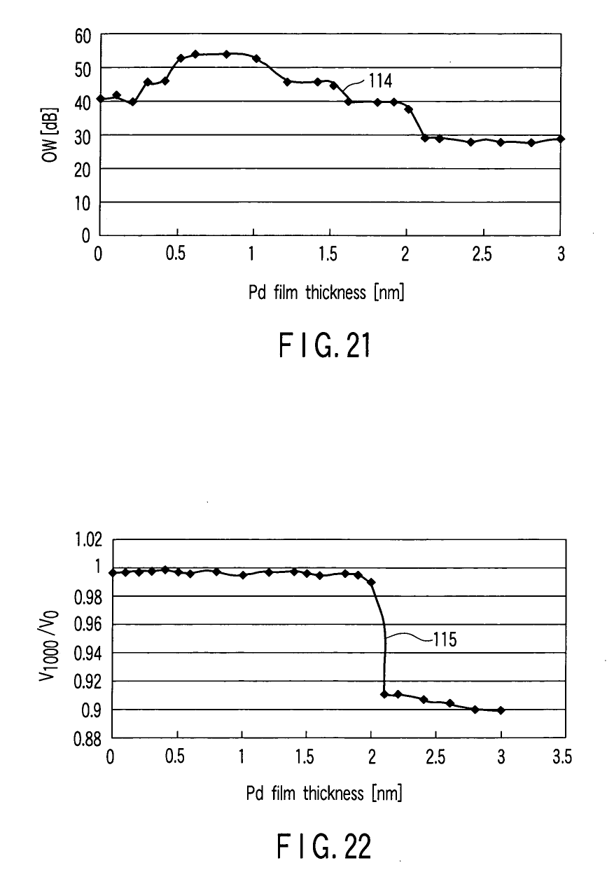

FIGS. 17, 18, 19, 20, 21, and 22 are graphs showing the changes in residual squareness ratio Rs, irreversible reversal magnetic field Hi, coercive force Hc, medium SNR, OW, and thermal decay resistance with respect to the Pd interlayer film thickness as curves 110, 111, 112, 113, 114, and 115, respectively.

When the Pd interlayer film thickness was 0.5 to 1.5 nm, the SNR and OW significantly improved, and the thermal decay resistance was high. On the other hand, when the Pd film thickness exceeded 2 nm, the irreversible reversal magnetic field Hi exceeded 0, and the thermal decay resistance decreased.

### Example 5

Perpendicular magnetic recording media were manufactured following the same procedures as in Example 4 except that a 0.8-nm thick film of any of Pt, Cu, Ti, Ru, Re, Ir, and Cr was formed, instead of Pd, as a nonmagnetic interlayer between a hard magnetic recording layer and soft magnetic recording layer. The Pt, Cu, Ti, Ru, Re, Ir, and Cr interlayers were formed by DC sputtering by using Pt, Cu, Ti, Ru, Re, Ir, and Cr targets 164 mm in diameter at an Ar pressure of 0.7 Pa and an input power of 100 W.

The results of the XRD evaluation showed that the magnetic crystal grains in the hard magnetic recording layer of any perpendicular magnetic recording medium had the hcp structure and were orientated in the (0001) plane.

The results of the planar TEM observation indicated that the hard magnetic recording layer of any perpendicular magnetic recording medium had the granular structure in which the grain boundary region surrounded the magnetic crystal grains. Also, the results of the composition analysis by TEM-EDX revealed that the magnetic crystal grains contained Co, Pt, and Cr.

Furthermore, the soft magnetic recording layer of any perpendicular magnetic recording medium had the granular structure in which the grain boundary region surrounded the magnetic crystal grains, similar to the hard magnetic recording layer. On the other hand, none of the nonmagnetic interlayers had the granular structure.

Table 3 below shows the residual squareness ratio Rs, irreversible reversal magnetic field Hi, coercive force Hc, medium SNR, OW, and thermal decay resistance of each perpendicular magnetic recording medium.

TABLE 3

| Nonmagnetic | | | | SNR | | |
|---|---|---|---|---|---|---|
| interlayer | Rs | Hi [kOe] | H [kOe] | [dB] | OW [dB] | V1000/V0 |
| None | 0.82 | −2.5 | 6.1 | 18.6 | 41 | 0.997 |
| Pd | 0.83 | −2.8 | 5.4 | 20.3 | 54 | 0.998 |
| Pt | 0.82 | −2.9 | 5.3 | 20.5 | 53 | 0.998 |
| Cu | 0.84 | −2.6 | 5.3 | 20.6 | 51 | 0.997 |
| Ti | 0.84 | −2.8 | 5.5 | 20.5 | 51 | 0.997 |
| Re | 0.82 | −2.6 | 5.5 | 20.1 | 57 | 0.997 |
| Ru | 0.88 | −2.6 | 5.2 | 20.0 | 57 | 0.999 |
| Ir | 0.82 | −2.6 | 5.5 | 20.0 | 57 | 0.997 |
| Cr | 0.84 | −2.8 | 5.5 | 20.1 | 56 | 0.998 |

Even when the interlayer was changed to Pt, Cu, Ti, Ru, Re, Ir, and Cr, the SNR and OW significantly improved, and the thermal decay resistance was high.

### Example 6

Perpendicular magnetic recording media were manufactured following the same procedures as in Example 4 except that a 0.8-nm thick film of any of Pd-8 mol % SiO₂, Pd-8 mol % TiO, Pd-8 mol % Cr₂O₃, Pd—Y₂O₃, Pd—MgO, Pd—Al₂O₃, and Pd—Ta₂O₅ was formed, instead of Pd, as a nonmagnetic interlayer. The Pd-8 mol % SiO₂, Pd-8 mol % TiO, Pd-8 mol % Cr₂O₃, Pd—Y₂O₃, Pd—MgO, Pd—Al₂O₃, and Pd—Ta₂O₃ interlayers were respectively formed by DC sputtering by using Pd-8 mol % SiO₂, Pd-8 mol % TiO, Pd-8 mol % Cr₂O₃, Pd—Y₂O₃, Pd—MgO, Pd—Al₂O₃, and Pd—Ta₂O₃ targets 164 mm in diameter at an Ar pressure of 0.7 Pa and an input power of 100 W.

The results of the XRD evaluation showed that the magnetic crystal grains in the hard magnetic recording layer of any perpendicular magnetic recording medium had the hcp structure and were orientated in the (0001) plane.

The results of the planar TEM observation indicated that the hard magnetic recording layer of any perpendicular magnetic recording medium had the granular structure in which the grain boundary region surrounded the magnetic crystal grains. Also, the results of the composition analysis by TEM-EDX revealed that the magnetic crystal grains contained Co, Pt, and Cr.

Furthermore, the soft magnetic recording layer of any perpendicular magnetic recording medium had the granular structure in which the grain boundary region surrounded the magnetic crystal grains, similar to the hard magnetic recording layer.

In addition, the nonmagnetic interlayer of any perpendicular magnetic recording medium had the granular structure in which the grain boundary region surrounded the magnetic crystal grains, similar to the hard magnetic recording layer.

Table 4 below shows the residual squareness ratio Rs, irreversible reversal magnetic field Hi, coercive force Hc, medium SNR, OW, and thermal decay resistance of each perpendicular magnetic recording medium.

TABLE 4

| Nonmagnetic | | | | SNR | | |
|---|---|---|---|---|---|---|
| interlayer | Rs | H [kOe] | Hc [kOe] | [dB] | OW [dB] | V1000/V0 |
| Pd | 0.83 | −2.8 | 5.4 | 20.3 | 54 | 0.998 |
| Pd—SiO₂ | 0.79 | −2.5 | 5.6 | 20.9 | 52 | 0.999 |
| Pd—TiO | 0.78 | −2.4 | 5.6 | 21.1 | 51 | 0.998 |
| Pd—Cr₂O₃ | 0.8 | −2.6 | 5.5 | 20.8 | 53 | 0.997 |
| Pd—MgO | 0.81 | −2.6 | 5.6 | 20.8 | 52 | 0.998 |
| Pd—Y₂O₃ | 0.81 | −2.7 | 5.5 | 20.7 | 51 | 0.997 |
| Pd—Al₂O₃ | 0.8 | −2.6 | 5.6 | 20.8 | 51 | 0.998 |
| Pd—Ta₂O₅ | 0.79 | −2.7 | 5.5 | 20.7 | 53 | 0.997 |

A comparison with Example 4 shows that the SNR increased more notably when the nonmagnetic interlayer had the granular structure.

### Example 7

Perpendicular magnetic recording media were manufactured following the same procedures as in Example 4 except that any of Ti, Re, and Pt₅₀Cr₅₀ was used instead of Ru as a nonmagnetic underlayer and a 4-nm thick Co₅₀Ni₅₀-8 mol % SiO₂ film was used as a soft magnetic recording layer. The Ti, Re, and Pt₅₀Cr₅₀ underlayers were respectively formed by DC sputtering by using Ti, Re, and PtCr targets 164 mm in diameter at an Ar pressure of 5 Pa and an input power of 1,000 W.

The results of the XRD evaluation showed that the magnetic crystal grains in the hard magnetic recording layer of any perpendicular magnetic recording medium had the hcp structure and were orientated in the (0001) plane.

The results of the planar TEM observation indicated that the hard magnetic recording layer of any perpendicular magnetic recording medium had the granular structure in which the grain boundary region surrounded the magnetic crystal grains. Also, the results of the composition analysis by TEM-EDX revealed that the magnetic crystal grains contained Co, Pt, and Cr.

Furthermore, the soft magnetic recording layer of any perpendicular magnetic recording medium had the granular structure in which the grain boundary region surrounded the magnetic crystal grains, similar to the hard magnetic recording layer.

Table 5 below shows the residual squareness ratio Rs, irreversible reversal magnetic field Hi, coercive force Hc, medium SNR, OW, and thermal decay resistance of each perpendicular magnetic recording medium.

TABLE 5

| Nonmagnetic | | | | |
|---|---|---|---|---|
| undercoating | Rs | Hi[kOe] | Hc[kOe] | SNR[dB] |
| Ru | 0.82 | −2.5 | 6.1 | 18.6 |
| Ti | 0.81 | −2.2 | 5.7 | 18.4 |
| Re | 0.8 | −2.1 | 5.6 | 18.2 |
| PtCr | 0.84 | −2.6 | 6.3 | 18.8 |

It was possible to obtain a high SNR and a good 0 W characteristic even when the nonmagnetic underlayer was made of Re, Ti, or Pt₅₀Cr₅₀.

### Example 8

A perpendicular magnetic recording medium was manufactured following the same procedures as in Example 4 except that the stacking positions of a hard magnetic recording layer and soft magnetic recording layer were switched and the nonmagnetic interlayer film thickness was fixed to 0.8 nm.

The results of the XRD evaluation showed that the magnetic crystal grains in the hard magnetic recording layer of the manufactured perpendicular magnetic recording medium had the hcp structure and were orientated in the (0001) plane.

The results of the planar TEM observation indicated that the hard magnetic recording layer of the manufactured perpendicular magnetic recording medium had the granular structure in which the grain boundary region surrounded the magnetic crystal grains. Also, the results of the composition analysis by TEM-EDX revealed that the magnetic crystal grains contained Co, Pt, and Cr.

Furthermore, the soft magnetic recording layer of the manufactured perpendicular magnetic recording medium had the granular structure in which the grain boundary region surrounded the magnetic crystal grains, similar to the hard magnetic recording layer.

Table 6 below shows the residual squareness ratio Rs, irreversible reversal magnetic field Hi, coercive force Hc, medium SNR, OW, and thermal decay resistance of the perpendicular magnetic recording medium.

TABLE 6

| | | | | SNR | | |
|---|---|---|---|---|---|---|
| | Rs | Hi [kOe] | Hc [kOe] | [dB] | OW [dB] | V1000/V0 |
| Example 4 | 0.83 | −2.8 | 5.4 | 20.3 | 54 | 0.998 |
| Example 6 | 0.82 | −2.7 | 5.5 | 20.4 | 53 | 0.998 |

A comparison with Example 4 reveals that it was possible to obtain a high SNR and a good OW characteristic even when the stacking positions of the hard magnetic recording layer and soft magnetic recording layer were switched.

### Example 9

Perpendicular magnetic recording media in which each of a soft magnetic underlayer, nonmagnetic interlayer, hard magnetic recording layer, and soft magnetic recording layer was multilayered to have two or more layers were manufactured as follows.

A 2.5-inch hard disk type nonmagnetic glass substrate (TS-10SX manufactured by OHARA) was placed in a vacuum chamber of the c-3010 sputtering apparatus manufactured by ANELVA.

After the vacuum chamber of the sputtering apparatus was evacuated to 1×10⁻⁵ Pa or less, a 50-nm thick Co₉₀Zr₅Nb₅ film as soft magnetic underlayer 1, a 0.8-nm thick Ru layer, and a 50-nm thick Co₉₀Zr₅Nb₅ film as soft magnetic underlayer 2 were sequentially stacked. On soft magnetic underlayer 2, a 3-nm thick Pt film as nonmagnetic underlayer 1 (a seed layer) and a 20-nm thick Ru film as nonmagnetic underlayer 2 were sequentially stacked.

On nonmagnetic underlayer 2, a 10-nm thick (Co₇₆—Cr₆—Pt₁₈)-8 mol % SiO₂ film as hard magnetic recording layer 1 and a (Co₇₆—Cr₆—Pt₁₈)-8 mol % TiO film as hard magnetic recording layer 2 were sequentially stacked.

After a 1-nm thick Pd film as a nonmagnetic interlayer was stacked on hard magnetic recording layer 2, a 2-nm thick Co₃₅Ni₆₅-8 mol % SiO₂ film as soft magnetic recording layer 1, a 2-nm thick Fe-8 mol % SiO₂ film as soft magnetic recording layer 2, and a 5-nm thick C film as a protective layer were sequentially formed. After the film formation, the surface of the protective layer was coated with a 13-Å thick perfluoropolyether (PFPE) lubricant by dipping, thereby obtaining perpendicular magnetic recording media.

When forming the films of Co₉₀Zr₅Nb₅, Pt, Ru, (Co₇₆—Cr₆—Pt₁₈)-8 mol % SiO₂, (Co₇₆—Cr₆—Pt₁₈)-8 mol % TiO, Pd, Co₃₅Ni₆₅-8 mol % SiO₂, Fe-8 mol % SiO₂, and C, the Ar pressures were respectively 0.7, 0.7, 5, 5, 5, 0.7, 0.7, 0.7, and 0.7 Pa, the targets used were respectively Co₉₀Zr₅Nb₅, Pt, Ru, (Co₇₆—Cr₆—Pt₁₈)-8 mol % SiO₂, (Co₇₆—Cr₆—Pt₁₈)-8 mol % TiO, Pd, Co₃₅Ni₆₅-8 mol % SiO₂, Fe-8 mol % SiO₂, and C targets each having a diameter of 164 mm, and the films were formed by DC sputtering. The input power to each target was 1,000 W. The distance between the target and substrate was 50 mm, and all the films were formed at room temperature.

The results of the XRD evaluation showed that the magnetic crystal grains in the hard magnetic recording layer of any perpendicular magnetic recording medium had the hcp structure and were orientated in the (0001) plane.

The results of the planar TEM observation indicated that the hard magnetic recording layer of any perpendicular magnetic recording medium had the granular structure in which the grain boundary region surrounded the magnetic crystal grains. Also, the results of the composition analysis by TEM-EDX revealed that the magnetic crystal grains contained Co, Pt, and Cr.

Furthermore, the soft magnetic recording layer of any perpendicular magnetic recording medium had the granular structure in which the grain boundary region surrounded the magnetic crystal grains, similar to the hard magnetic recording layer.

Table 7 below show the medium SNR, OW, and thermal decay resistance of each perpendicular magnetic recording medium.

TABLE 7

| | | | | | Hard | Hard | Soft | | | |
|---|---|---|---|---|---|---|---|---|---|---|
| | Soft | Soft | | | magnetic | magnetic | magnetic | | | |
| | magnetic | magnetic | Nonmagnetic | Nonmagnetic | recording | recording | recording | SNR | OW | V1000/ |
| Sample | underlayer 1 | underlayer 2 | underlayer 1 | underlayer 2 | layer 1 | layer 2 | layer 1 | [dB] | [dB] | V0 |
| 10-1 | CoZrNb | None | Ru | None | CoCrPt—SiO2 | None | CoNi—SiO2 | 20.3 | 54 | 0.998 |
| | (100 nm) | | (20 nm) | | (20 nm) | | (4 nm) | | | |
| 10-2 | CoZrNb | CoZrNb | Ru | None | CoCrPt—SiO2 | None | CoNi—SiO2 | 20.6 | 58 | 0.998 |
| | (50 nm) | (50 nm) | (20 nm) | | (20 nm) | | (4 nm) | | | |
| 10-3 | CoZrNb | CoZrNb | Pt | Ru | CoCrPt—SiO2 | None | CoNi—SiO2 | 20.9 | 55 | 0.998 |
| | (50 nm) | (50 nm) | (6 nm) | (20 nm) | (20 nm) | | (4 nm) | | | |
| 10-4 | CoZrNb | CoZrNb | Pt | Ru | CoCrPt—SiO2 | CoCrPt—TiO | CoNi—SiO2 | 21.2 | 54 | 0.997 |
| | (50 nm) | (50 nm) | (6 nm) | (20 nm) | (10 nm) | (10 nm) | (4 nm) | | | |
| 10-5 | CoZrNb | CoZrNb | Pt | Ru | CoCrPt—SiO2 | CoCrPt—TiO | CoNi—SiO2 | 21.5 | 59 | 0.998 |
| | (50 nm) | (50 nm) | (6 nm) | (20 nm) | (10 nm) | (10 nm) | (2 nm) | | | |

Table 7 demonstrate that the SNR and OW characteristic improved when each of the soft magnetic underlayer, nonmagnetic underlayer, hard magnetic recording layer, and soft magnetic recording layer was multilayered.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A perpendicular magnetic recording medium comprising:
a substrate;
a soft magnetic underlayer formed on the substrate;
a nonmagnetic underlayer formed on the soft magnetic underlayer; and
a magnetic recording layer formed on the nonmagnetic underlayer and including a hard magnetic recording layer and a soft magnetic recording layer,
wherein each of the hard magnetic recording layer and the soft magnetic recording layer has magnetic crystal grains and a grain boundary region surrounding the magnetic crystal grains,
the magnetic crystal grains in the hard magnetic recording layer contain Co and Pt, has an hcp structure, and are orientated in a (0001) plane, and
the magnetic recording layer has a residual squareness ratio of not more than 0.95 and an irreversible reversal magnetic field of not more than 0 Oe on a magnetization curve when a magnetic field perpendicular to a substrate surface is applied.

2. A medium according to claim 1, wherein the residual squareness ratio on the magnetization curve is 0.7 (inclusive) to 0.9 (inclusive).

3. A medium according to claim 1, wherein the irreversible reversal magnetic field on the magnetization curve is −3.5 to −0.5 kOe.

4. A medium according to claim 1, wherein the magnetic crystal grains in the soft magnetic recording layer are made of a metal component containing iron and/or cobalt at not less than 35% as a total atomic ratio.

5. A medium according to claim 4, wherein the metal component comprises a cobalt-nickel alloy containing 45 to 80 at. % of cobalt.

6. A medium according to claim 1, wherein the grain boundary region in the hard magnetic recording layer contains a compound selected from the group consisting of an oxide, a nitride, and a carbide, and the compound contains at least one element selected from the group consisting of silicon, titanium, chromium, aluminum, magnesium, tantalum, and yttrium.

7. A medium according to claim 1, wherein the grain boundary region in the soft magnetic recording layer contains a compound selected from the group consisting of an oxide, a nitride, and a carbide, and the compound contains at least one element selected from the group consisting of silicon, titanium, chromium, aluminum, magnesium, tantalum, and yttrium.

8. A medium according to claim 1, further comprising a nonmagnetic interlayer formed between the hard magnetic recording layer and the soft magnetic recording layer.

9. A medium according to claim 8, wherein the nonmagnetic interlayer has a thickness of 0.3 to 1.5 nm.

10. A medium according to claim 8, wherein the nonmagnetic interlayer contains a metal component containing at least one element selected from the group consisting of palladium, platinum, copper, titanium, ruthenium, rhenium, iridium, and chromium.

11. A medium according to claim 10, wherein the nonmagnetic interlayer has nonmagnetic crystal grains and a grain boundary region surrounding the nonmagnetic crystal grains, and the grain boundary region is made of one of an oxide, nitride, and carbide of at least one of silicon, titanium, chromium, aluminum, magnesium, tantalum, and yttrium.

12. A medium according to claim 1, wherein the nonmagnetic underlayer contains at least one metal component selected from the group consisting of ruthenium, titanium, and platinum.

13. A magnetic recording/reproducing apparatus comprising:
a perpendicular magnetic recording medium which includes
a substrate,
a soft magnetic underlayer formed on the substrate,
a nonmagnetic underlayer formed on the soft magnetic underlayer, and
a magnetic recording layer formed on the nonmagnetic underlayer and including a hard magnetic recording layer and a soft magnetic recording layer, and
in which each of the hard magnetic recording layer and the soft magnetic recording layer has magnetic crystal grains and a grain boundary region surrounding the magnetic crystal grains,
the magnetic crystal grains in the hard magnetic recording layer contain Co and Pt, has an hcp structure, and are orientated in a (0001) plane, and
the magnetic recording layer has a residual squareness ratio of not more than 0.95 and an irreversible reversal magnetic field of not more than 0 Oe on a magnetization curve when a magnetic field perpendicular to a substrate surface is applied; and
a recording/reproducing head.

14. An apparatus according to claim 13, wherein the residual squareness ratio on the magnetization curve is 0.7 (inclusive) to 0.9 (inclusive).

15. An apparatus according to claim 13, wherein the irreversible reversal magnetic field on the magnetization curve is −3.5 to −0.5 kOe.

16. An apparatus according to claim 13, wherein the magnetic crystal grains in the soft magnetic recording layer are made of a metal component containing iron and/or cobalt at not less than 35% as a total atomic ratio.

17. An apparatus according to claim 16, wherein the metal component comprises a cobalt-nickel alloy containing 45 to 80 at. % of cobalt.

18. An apparatus according to claim 13, wherein the grain boundary region in the hard magnetic recording layer contains a compound selected from the group consisting of an oxide, a nitride, and a carbide, and the compound contains at least one element selected from the group consisting of silicon, titanium, chromium, aluminum, magnesium, tantalum, and yttrium.

19. An apparatus according to claim 13, wherein the grain boundary region in the soft magnetic recording layer contains a compound selected from the group consisting of an oxide, a nitride, and a carbide, and the compound contains at least one element selected from the group consisting of silicon, titanium, chromium, aluminum, magnesium, tantalum, and yttrium.

20. An apparatus according to claim 13, further comprising a nonmagnetic interlayer formed between the hard magnetic recording layer and the soft magnetic recording layer.

21. An apparatus according to claim 20, wherein the nonmagnetic interlayer has a thickness of 0.3 to 1.5 nm.

22. An apparatus according to claim 20, wherein the nonmagnetic interlayer contains a metal component containing at least one element selected from the group consisting of palladium, platinum, copper, titanium, ruthenium, rhenium, iridium, and chromium.

23. An apparatus according to claim 20, wherein the nonmagnetic interlayer has nonmagnetic crystal grains and a grain boundary region surrounding the nonmagnetic crystal grains, and the grain boundary region is made of one of an oxide, nitride, and carbide of at least one of silicon, titanium, chromium, aluminum, magnesium, tantalum, and yttrium.

24. An apparatus according to claim 13, wherein the nonmagnetic underlayer contains at least one metal component selected from the group consisting of ruthenium, titanium, and platinum.
